(19) United States
(12) Patent Application Publication
(10) Pub. No.: US 2021/0277237 A1
(43) Pub. Date: Sep. 9, 2021

(54) CURABLE SILICONE COMPOSITION

(71) Applicants: ELKEM SILICONES SHANGHAI CO., LTD., SHANGHAI (CN); ELKEM SILICONES FRANCE SAS, LYON (FR)

(72) Inventors: Liya JIA, SHANGHAI (CN); Yuanzhi YUE, SHANGHAI (CN); Dongsheng WANG, SHANGHAI (CN); Jean-Marc FRANCES, SAINT-FONS CEDEX (FR)

(21) Appl. No.: 16/973,033

(22) PCT Filed: Jun. 8, 2018
(86) PCT No.: PCT/CN2018/090403

§ 371 Date: Dec. 8, 2020

(51) Int. Cl. C08L 83/04; B33Y 70/10

(52) U.S. Cl. CPC C08L 83/04; B33Y 70/10; B29C 64/124; C08L 2205/025; C08L 2205/035

(57) ABSTRACT

A curable silicone composition is described. Also described, is a method of producing a three-dimensional (3D) printed article with a curable silicone composition involving epoxy-related photocuring and hydrosilylation curing. In exemplary embodiments, the resulting three-dimensional (3D) printed article thus formed and the curable silicone composition or the resulting three-dimensional (3D) printed article can be used in electronics applications and/or in 3D printing.

### TECHNICAL FIELD

The field of the invention is that of a curable silicone composition. More specifically, the present invention relates to a method for producing a three-dimensional (3D) printed article with a curable silicone composition involving epoxy-related photocuring and hydrosilylation curing, to the three-dimensional (3D) printed article thus formed and the use of the curable silicone composition or the three-dimensional (3D) printed article in electronics application or in 3D printing.

### BACKGROUND ART

A curable silicone composition can be cured via various reactions such as hydrosilylation, polycondensation and ring opening polymerization. The cross-linking of the curable silicone composition can be initiated by one or more mechanisms. Among these mechanisms, heat-curing mechanism, moisture-curing mechanism and photocuring mechanism are three main initiating mechanisms usually used to initiate cross-linking of reactive silicone. Based on different curing or cross-linking mechanisms, various silicone materials can be obtained and applied in different fields such as electronics, aerospace, high speed train, automobile, architecture, and the like.

However, in practical applications, requirements on silicone materials and curing processes are so complicated that desired properties sometimes cannot be obtained when only one kind of curing mode is involved. Thus, a dual-curing silicone composition is an option to provide a comprehensive solution.

The dual-curing silicone compositions disclosed in U.S. Pat. Nos. 7,105,584 and 6,451,870 incorporate UV-initiated crosslinking mechanism and moisture-initiated crosslinking mechanism. However, these dual-curing silicone compositions have some disadvantages. Firstly, it is difficult to realize in-depth curing when the curing layer is quite thick. Secondly, small volatile molecules resulting from moisture-initiated curing are unfavourable due to their smell, corrosivity, toxicity or lability.

These problems are particularly prominent in the field of 3D printing.

3D printing or additive manufacturing (AM), which encompasses a variety of different technologies, can be used to create a three-dimensional object of almost any shape or geometry, especially suitable for obtaining articles with very complex geometry and/or structure. The main 3D printing technologies are for example, Extrusion 3D printing, UV-Stereolithography (SLA), UV-Digital Light processing (DLP), Continuous Liquid Interface Production (CLIP), Inkjet Deposition and so on.

Extrusion 3D printing process is disclosed, for example, in WO2015107333, WO2016109819 and WO2016134972. For example, in this process, the material is extruded through a nozzle to print one cross-section of an object, which may be repeated for each layer. An energy source can be attached directly to the nozzle such that it immediately follows extrusion for immediate cure or can be separated from the nozzle for delayed cure. The nozzle or build platform generally moves in the X-Y (horizontal) plane before moving in the Z-axis (vertical) plane once each layer is complete. The UV cure can be immediate after deposition or the plate moves under UV light to give a delay between deposition and UV cure. A support material may be used in order to avoid extruding a filament material in the air. Some post-processing treatments may be used to improve the quality of the printed surface.

UV-Stereolithography (SLA) is disclosed, for example, in WO2015197495. For example, UV-Stereolithography (SLA) uses laser beam which is generally moved in the X-Y (horizontal) plane by a scanner system. Motors guided by information from the generated data source drive mirrors that send the laser beam over the surface.

UV-Digital Light processing (DLP) is disclosed, for example, in WO 2016181149 and US20140131908. For example, UV-Digital Light processing (DLP) sends 3D model to the printer, and a vat of liquid polymer is exposed to light from a DLP projector under safelight conditions. The DLP projector displays the image of the 3D model onto the liquid polymer. The DLP projector can be installed under the UV-light shines through a window made of transparent silicone elastomeric membrane.

Continuous Liquid Interface Production (CLIP, originally Continuous Liquid Interphase Printing) is disclosed, for example, in WO2014126837 and WO2016140891, which, for example, uses photo polymerization to create smooth-sided solid objects of a wide variety of shapes.

Inkjet Deposition is disclosed, for example, in WO201740874, WO2016071241, WO2016134972, WO2016188930, WO2016044547 and WO2014108364, which, for example, uses material jetting printer which has a print head moving around a print area jetting the particular liquid curable composition for example by UV polymerization. The ability of the inkjet nozzle to form a droplet, as well as its volume and its velocity, are affected by the surface tension of the material.

Accordingly, in the field of 3D printing, higher requirements are placed on the raw materials, such as curable silicone compositions.

For example, in 3D printing application, fast curing or at least fast shape figuration is needed, and meanwhile various advantageous properties such as mechanical properties are also needed. However, curing speed by hydrosilylation or polycondensation is usually relatively slow. Although UV curing system may provide a relatively fast shape figuration, comprehensive mechanical properties usually cannot be obtained by only using such system due to the limitation on its raw materials. For example, UV-curable epoxy-functional silicone materials currently available in the market often lead to brittle and hard products and also are relatively expensive.

WO 2015006531 A1 from the company Momentive Performance Mat Inc discloses a dual-modality curing silicone composition, which comprises the reaction product of at least one hydride-functional silicone, at least one unsaturated-functional silicone and at least one epoxy or oxetane functional silicone and may optionally comprise a catalyst, a photoinitiator, a filler, a photosensitizer, a stabilizer, an inhibitor and an adhesion promoter. Said dual-modality curing silicone composition is capable of being cured by two different curing modalities or capable of simultaneous curing utilizing those different curing modalities. The silicone composition possesses enhanced hydrophilicity, physical properties and optical properties which can be used in applications such as transdermal patches for healthcare and pharmaceutical applications, drug delivery devices, coating, cosmetic structuring material, gasketing materials, agricultural spray, homecare products, rubbers and other applications where hydrophilicity is required. However, it seems that it is difficult for this composition to achieve fast initial curing and subsequent further curing and is therefore not suitable for some applications such as some 3D printings.

### CONTENTS OF THE INVENTION

The present invention provides a method for producing a three-dimensional (3D) printed article by using a curable silicone composition, which not only allows fast initial curing but also can be customized on demands, and thus can be used in a multitude of applications, such as 3D printing, electronics, aerospace, high speed train, automobile, architecture, and the like.

Accordingly, it is an objective of the present invention to propose a method for producing a three-dimensional (3D) printed article which uses a curable silicone composition involving epoxy-related photocuring and hydrosilylation curing, which allows fast initial curing and has high flexibility of adjusting the properties of the silicone materials to meet various demands.

Further another objective of the present invention is to provide a three-dimensional (3D) printed article formed in accordance with the method of the invention.

Another objective of the present invention relates to the use of said three-dimensional (3D) printed article or said curable silicone composition in electronics application or in 3D printing.

The present curable silicone composition according to the invention is particularly well suited for 3D printing since it offers a superior route to realize fast initial curing to get fast shape figuration by epoxy-related photocuring and also to provide comprehensive properties by hydrosilylation reaction, including desired mechanical properties such as tensile strength, elongation at break and tear strength.

The present curable silicone composition can be used in various 3D printing technologies, for example, Extrusion 3D printing, UV-Stereolithography (SLA), UV-Digital Light processing (DLP), Continuous Liquid Interface Production (CLIP) and Inkjet Deposition. These technologies and the related 3D printing equipments are well known in the art. The person skilled in the art well knows how to choose and use a suitable 3D printing technology and the related 3D printing equipment and then apply the present curable silicone composition in the 3D printing technology by using the related 3D printing equipment.

These objectives, among others, are achieved by the present invention which relates to a method for producing a three-dimensional (3D) printed article, the method comprising the steps of:

(i) providing a curable silicone composition, comprising:

A. at least one organopolysiloxane comprising, per molecule, at least two alkenyl or alkynyl groups bonded to silicon atoms;

B. at least one organohydrogenopolysiloxane comprising, per molecule, at least two hydrogen atoms bonded to silicon atoms, and preferably at least three hydrogen atoms bonded to silicon atoms;

C. at least one hydrosilylation catalyst, preferably chosen from the compounds of a metal belonging to the platinoids such as platinum and rhodium, more preferably chosen from platinum compounds such as chloroplatinic acid, or platinum complexes such as platinum/vinylsiloxane complexes or the Karstedt catalyst which is constituted of platinum complexes with divinyltetramethyldisiloxane as ligand, or mixtures thereof;

D. at least one epoxy-functional organosilicon compound;

E. at least one cationic photoinitiator;

F. optionally, at least one filler and/or at least one silicone resin;

G. optionally, at least one hydrosilylation inhibitor, and

H. optionally at least one photosensitizer,

(ii) printing said curable silicone composition with a 3D printer to form a printed composition,
(iii) photo polymerizing at least part of the total number of epoxy groups of the printed composition while printing to provide an at least partially solidified layer,
(iv) optionally, repeating one or more times steps (ii) and (iii) onto said at least partially solidified layer previously obtained until a desired shape is obtained, and
(iv) allowing hydrosilylation curing to complete for said at least partially solidified layer(s) to obtain solidified layer(s), preferentially by heating at a temperature in the range of 40° C. to 190° C., and hence obtaining said 3D printed article.

It is within the capability of the person skilled in the art to determine the time required for the composition to complete the curing, in particular the hydrosilylation curing, and the time required for the initial epoxy-related UV curing according to the formulations of the silicone compositions.

The inventors surprisingly found out that by providing a curable silicone system involving epoxy-related photocuring and hydrosilylation curing, it is possible to obtain silicone materials combining the advantages of these two types of curing processes. Specifically, by choosing the components used, the present curable silicone composition undergoes the following curing processes: the first step mainly involves epoxy-related photocuring, then the second step is to continue the uncompleted hydrosilylation curing. The epoxy-related photocuring is initiated by means of radiation such as UV light to realize a fast-initial curing. The hydrosilylation curing may be achieved with or without heat and/or radiation to realize an in-depth curing. According to a particular embodiment, the present curable silicone composition may be heated, for example, to a temperature of at least 40° C., preferably between 40° C. and 190° C., so as to accelerate the curing of the present curable silicone composition.

For example, the epoxy-related photocuring is initiated by means of radiation whose wavelength is preferably between 200 nm and 800 nm, preferably a UV radiation whose wavelength is preferably between 200 nm and 400 nm. The UV lamps commonly used are mercury-vapor UV lamps (high pressure, low pressure and above all medium pressure). These lamps may be doped with gallium-indium, with iron or with lead to modify the emission wavelength. The metals contained in these lamps may be excited by electric arc and microwave discharge. Other sources of radiation that are currently industrially available are LEDs and also halogen lamps.

Thus, the present curable silicone composition allows high flexibility to obtain various desired properties via hydrosilylation curing, including good mechanical properties such as tensile strength, elongation at break and tear strength and so on, and meanwhile, fast initial curing can also be guaranteed via epoxy-related photocuring. Therefore, the present curable silicone composition is advantageous for many applications, especially for 3D printing or electronics application.

The polyorganosiloxane A bears, per molecule, at least two alkenyl or alkynyl groups bonded to silicon atoms. According to a preferred embodiment, this polyorganosiloxane A comprises:

(i) at least two units of formula (A1):

YₐZ_{b}SiO_{(4-(a+b)/2} (A1)

in which:
Y represents a monovalent radical containing from 2 to 12 carbon atoms, having at least one alkene or alkyne function and optionally at least one heteroatom,
Z represents a monovalent radical containing from 1 to 20 carbon atoms and not comprising any alkene or alkyne function;
a and b represent integers, a being 1, 2 or 3, b being 0, 1 or 2 and (a+b) being 1, 2 or 3;

(ii) and optionally other units of formula (A2):

Z_{c}SiO_{(4-c)/2} (A2)

in which:
Z has the same meaning as above, and
c represents an integer between 0 and 3.

It is understood in formula (A1) and in formula (A2) above that, if several radicals Y and Z are present, they may be identical to or different from each other.

In formula (A1), the symbol “a” may preferably be 1 or 2, more preferably 1.

Furthermore, in formula (A1) and in formula (A2), Z may represent a monovalent radical chosen from the group constituted by an alkyl group containing 1 to 8 carbon atoms, optionally substituted with at least one halogen atom, and an aryl group. Z may advantageously represent a monovalent radical chosen from the group constituted by methyl, ethyl, propyl, 3,3,3-trifluoropropyl, xylyl, tolyl and phenyl.

In addition, in formula (A1), Y may advantageously represent a radical chosen from the group constituted by vinyl, propenyl, 3-butenyl, 5-hexenyl, 9-decenyl, 10-undecenyl, 5,9-decadienyl and 6,11-dodecadienyl.

The polyorganosiloxane A may represent a linear, branched, cyclic or network structure.

When it concerns linear polyorganosiloxanes, they may be constituted essentially of:
siloxyl units “D” chosen from the units of formulae Y₂SiO_{2/2}, YZSiO_{2/2} and Z₂SiO_{2/2};
siloxyl units “M” chosen from the units of formulae Y₃SiO_{1/2}, Y₂ZSiO_{1/2}, YZ₂SiO_{1/2} and Z₃SiO_{1/2}.

As examples of units “D”, mention may be made of dimethylsiloxy, methylphenylsiloxy, methylvinylsiloxy, methylbutenylsiloxy, methylhexenylsiloxy, methyldecenylsiloxy and methyldecadienylsiloxy groups.

As examples of units “M”, mention may be made of trimethylsiloxy, dimethylphenylsiloxy, dimethylvinylsiloxy and dimethylhexenylsiloxy groups.

These linear polyorganosiloxanes may be oils with a dynamic viscosity at 25° C. of between 1 mPa·s and 1 000 000 mPa·s, preferably between 10 mPa·s and 100 000 mPa·s, or gums with a dynamic viscosity at 25° C. of greater than 1 000 000 mPa·s.

When it concerns cyclic polyorganosiloxanes, they may be constituted of siloxyl units “D” chosen from the units of formulae Y₂SiO_{2/2}, YZSiO_{2/2} and Z₂SiO_{2/2}. Examples of such units “D” are described above. These cyclic polyorganosiloxanes may have a dynamic viscosity at 25° C. of between 1 mPa·s and 5000 mPa·s.

The term “dynamic viscosity” is intended to mean the shear stress which accompanies the existence of a flow-rate gradient in the material. All the viscosities to which reference is made in the present report correspond to a magnitude of dynamic viscosity which is measured, in a manner known per se, at 25° C. The viscosity is generally measured using a Brookfield viscometer.

Examples of polyorganosiloxanes A are:
polydimethylsiloxanes bearing dimethylvinylsilyl end groups;
poly(methylphenylsiloxane-co-dimethylsiloxane)s bearing dimethylvinylsilyl end groups;
poly(vinylmethylsiloxane-co-dimethylsiloxane)s bearing dimethylvinylsilyl end groups;
poly(dimethylsiloxane-co-vinylmethylsiloxane)s bearing trimethylsilyl end groups;
cyclic polymethylvinylsiloxanes.

According to a preferred embodiment, the content of alkenyls or alkynyls in the polyorganosiloxane A is 0.0001-30% by weight, preferably 0.001-10% by weight, relative to the total weight of polyorganosiloxane A.

The organohydrogenopolysiloxane B bears, per molecule, at least two hydrogen atoms bonded to silicon atoms, and preferably at least three hydrogen atoms bonded to silicon atoms. According to a preferred embodiment, this polyorganosiloxane B comprises:

(i) at least two units of formula (B1), and preferably at least three units of formula (B1):

H_{d}LₑSiO_{(4-(d+e))/2} (B1)

in which:
L represents a monovalent radical other than a hydrogen atom,
H represents a hydrogen atom,
d and e represent integers, d being 1 or 2, e being 0, 1 or 2 and (d+e) being 1, 2 or 3;

and optionally other units of formula (B2):

L_{f}SiO_{(4-f)/2} (B2)

in which:
L has the same meaning as above, and
f represents an integer between 0 and 3.

It is understood in formula (B1) and in formula (B2) above that if several groups L are present, they may be identical to or different from each other.

In formula (B1), the symbol d may preferably be 1.

Furthermore, in formula (B1) and in formula (B2), L may represent a monovalent radical chosen from the group constituted by an alkyl group containing 1 to 8 carbon atoms, optionally substituted with at least one halogen atom, and an aryl group. L may advantageously represent a monovalent radical chosen from the group constituted by methyl, ethyl, propyl, 3,3,3-trifluoropropyl, xylyl, tolyl and phenyl. Examples of units of formula (B1) are the following: H(CH₃)₂SiO_{1/2}, HCH₃SiO_{2/2} and H(C₆H₅)SiO_{2/2}.

The polyorganosiloxane B may represent a linear, branched, cyclic or network structure.

When linear polyorganosiloxanes are concerned, they may be constituted essentially of:
siloxyl units “D” chosen from the units of formulae HLSiO_{2/2} and L₂SiO_{2/2};
siloxyl units “M” chosen from the units of formulae HL₂SiO_{1/2} and L₃SiO_{1/2}.

These linear polyorganosiloxanes may be oils with a dynamic viscosity at 25° C. of between 1 mPa·s and 100 000 mPa·s, preferably between 10 mPa·s and 5 000 mPa·s, or gums with a dynamic viscosity at 25° C. of greater than 100 000 mPa·s.

When cyclic polyorganosiloxanes are concerned, they may be constituted of siloxyl units “D” chosen from the units of formulae HLSiO_{2/2} and L₂SiO_{2/2}, or of siloxyl units of formula HLSiO_{2/2} only. The units of formula L₂SiO_{2/2} may especially be dialkylsiloxy or alkylarylsiloxy. These cyclic polyorganosiloxanes may have a dynamic viscosity at 25° C. of between 1 mPa·s and 5 000 mPa·s.

Examples of polyorganosiloxanes B are:
polydimethylsiloxanes bearing hydrogenodimethylsilyl end groups;
poly(dimethylsiloxane-co-hydrogenomethylsiloxane)s bearing trimethylsilyl end groups;
poly(dimethylsiloxane-co-hydrogenomethylsiloxane)s bearing hydrogenodimethylsilyl end groups;
polyhydrogenomethylsiloxanes bearing trimethylsilyl end groups;
cyclic hydrogenomethylpolysiloxanes.

When branched or network polyorganosiloxanes are concerned, they may also comprise:
siloxyl units “T” chosen from the units of formulae HSiO_{3/2} and LSiO_{3/2};
siloxyl units “Q” of formula SiO_{4/2}.

Preferably, the content of SiHs in the polyorganosiloxane B is 0.001-50% by weight, preferably 0.01-46% by weight, relative to the total weight of polyorganosiloxane B.

Advantageously, the present curable silicone composition contains organopolysiloxane A and organohydrogenopolysiloxane B in proportions such that the mole ratio of the hydrogen atoms bonded to silicon atoms in the organohydrogenopolysiloxane B to the alkenyl or alkynyl groups bonded to silicon atoms in the organopolysiloxane A is between 0.1 and 10, and more preferably between 0.5 and 5.

As hydrosilylation catalyst C that is of use according to the invention, mention may be made of the compounds of a metal belonging to the platinum group well known to those skilled in the art. The metals of the platinum group are those known as platinoids, a name which groups together, in addition to platinum, ruthenium, rhodium, palladium, osmium and iridium. Platinum and rhodium compounds are preferably used. Use may in particular be made of the complexes of platinum and of an organic product described in patents U.S. Pat. Nos. 3,159,601, 3,159602, 3,220,972 and European patents EP A 0 057 459, EP-A-0 188 978 and EP-A-0 190 530, and the complexes of platinum and of vinylorganosiloxanes described in patent U.S. Pat. No. 3,419,593. The catalyst that is generally preferred is platinum. By way of examples, mention may be made of platinum black, chloroplatinic acid, an alcohol-modified chloroplatinic acid, a complex of chloroplatinic acid with an olefin, an aldehyde, a vinylsiloxane or an acetylenic alcohol, inter alia. Preference is given to the Karstedt solution or complex, as described in patent U.S. Pat. No. 3,775,452, to chloroplatinic acid hexahydrate or a platinum catalyst comprising carbene ligands.

Preferably, the hydrosilylation catalyst C is based on Pt chosen from the group consisting of platinum compounds such as chloroplatinic acid, or platinum complexes such as platinum/vinylsiloxane complexes or the Karstedt catalyst which is constituted of platinum complexes with divinyltetramethyldisiloxane as ligand, or mixtures thereof.

The present curable silicone composition comprises at least one epoxy-functional organosilicon compound D. Preferably, the epoxy-functional organosilicon compound D is a polyorganosiloxane comprising at least two silicon atoms and comprising:
at least one siloxyl unit of formula (D1) and preferably at least two siloxyl units of formula (D1) below:

Z¹(R⁰)ₐSiO_{(3-a)/2} (D1)

wherein:
a=0, 1 or 2,
R⁰, which may be identical or different when a >1, represents an alkyl, cycloalkyl, aryl, alkenyl, hydrogeno or alkoxy radical and preferably a C₁ to C₆ alkyl,
Z¹ represents epoxy function, and
optionally at least one siloxyl unit of formula (D2) below:

$${R}_{f} {SiO}_{\frac{4 - f}{2}} \qquad ( D1 )$$

wherein:
f=0, 1, 2 or 3, and
the symbols R represent, independently of one another, monovalent radicals chosen from the group consisting of an alkyl, a cycloalkyl, an aryl, an alkenyl, a hydrogeno radical and an alkoxy radical.

According to another embodiment, the epoxy-functional organosilicon compound D is liquid at ambient temperature or heat-fusible at a temperature below 100° C., is polyorganosiloxane in nature and consists of siloxyl units of formula (D3) and ending with siloxyl units of formula (D4) or cyclic units consisting of siloxyl units of formula (D3) represented below:

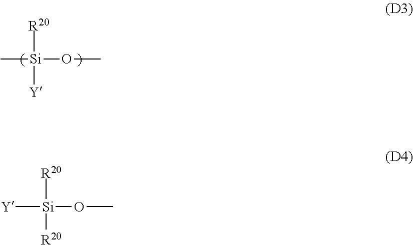

wherein:
the symbols R²⁰ are identical or different and represent:
   a linear or branched alkyl radical containing from 1 to 8 carbon atoms, optionally substituted with at least one halogen, preferably fluorine, the alkyl radicals preferably being methyl, ethyl, propyl, octyl or 3,3,3-trifluoropropyl,
   an optionally substituted cycloalkyl radical containing from 5 to 8 carbon atoms,
   an aryl radical containing from 6 to 12 carbon atoms which may be substituted, preferably phenyl or dichlorophenyl, or
   an arylalkyl part having an alkyl part containing from 5 to 14 carbon atoms and an aryl part containing from 6 to 12 carbon atoms, which is optionally substituted on the aryl part with halogens, alkyls and/or alkoxyls containing from 1 to 3 carbon atoms, and
the symbols Y′ are identical or different and represent epoxy function and which can be linked to the silicon atom by means of a divalent radical containing from 2 to 20 carbon atoms and which can optionally contain at least one heteroatom, preferably oxygen.

According to another advantageous embodiment, the epoxy-functional organosilicon compound D is a polyorganosiloxane with epoxide contents ranging from 0.001 to 60 wt. %, preferably 0.01 to 30 wt. %, based on the total weight of epoxy-functional organosilicon compound D. Examples of polyorganosiloxanes with epoxy organofunctional groups (“epoxy-functional polyorganosiloxanes”) are found in particular in patents DE-A-4.009.889, EP-A-396.130, EP-A-355.381, EP-A-105.341, FR-A-2.110.115 or FR-A-2.526.800. The epoxy-functional polyorganosiloxanes can be prepared by hydrosilylation reaction between oils comprising Si-H units and epoxy-functional compounds such as 4-vinylcyclohexene oxide or allyl glycidyl ether.

When the epoxy-functional organosilicon compound D is a polyorganosiloxane, it is generally in the form of a fluid having a linear chemical structure with a dynamic viscosity of about 1 to 1 000 000 mPa·s at 25° C., generally of about 5 to 500 000 mPa·s at 25° C., and even more preferentially of 10 to 100 000 mPa·s at 25° C., or gums having a molecular weight of about 1 000 000 or more.

When cyclic polyorganosiloxanes are involved, they consist of units (D3) which may be, for example, of the dialkylsiloxy or alkylarylsiloxy type. These cyclic polyorganosiloxanes have a viscosity of about 1 to 100 000 mPa·s, preferable 10 to 100 000 mPa·s.

According to another embodiment, the epoxy-functional organosilicon compound D is a silane comprising epoxy function.

Preferably, the epoxy function is chosen from the following groups (1) to (6):

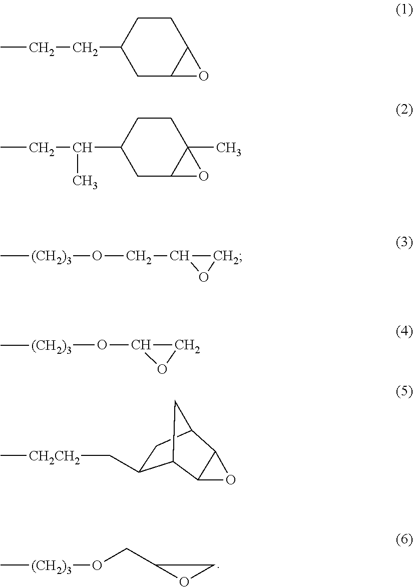

When the epoxy-functional organosilicon compound D is a polyorganosiloxane, it is preferably chosen from the group consisting of the following compounds (7) to (14):

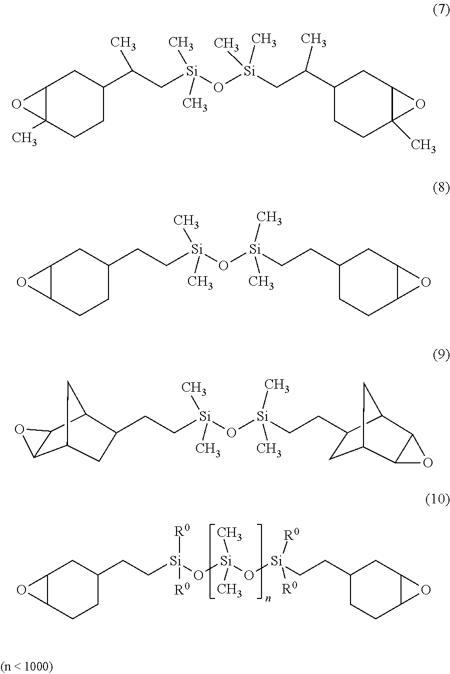

in which formulae R⁰ is a C₁ to C₂₀ alkyl group and preferably a methyl group;

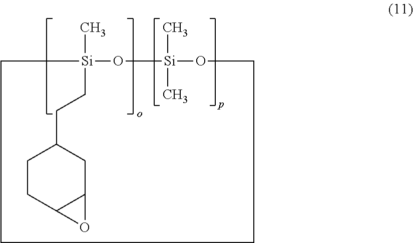

in which o and p are integers, the sum o+p<10000 and the symbol o is >1;

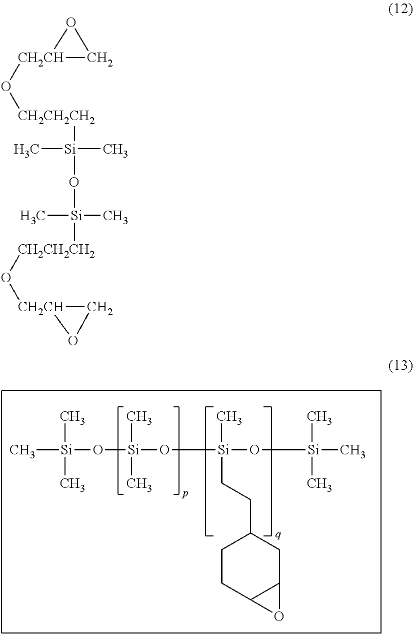

in which p=10 to 100 000, preferably p=10 to 10 000; and

q=1 to 300, preferably q=2 to 50;

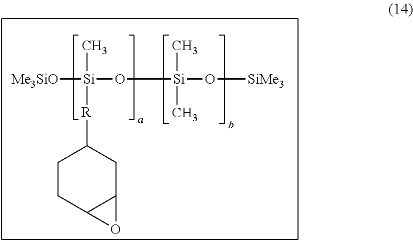

in which Me represents methyl;

a=1 to 10000, preferably a=2 to 1 000; and more preferably a=3 to 1000;

b=1 to 10000, preferably a=2 to 1 000; and more preferably a=2.5 to 1000.

When the epoxy-functional organosilicon compound D is a silane, it is preferably the following silane:

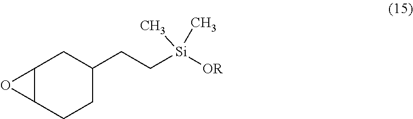

with R=C₁ to C₁₀ alkyl group.

Preferably, the content of epoxy groups in the epoxy-functional organosilicon compound D is from 0.001 to 60 wt. %, preferably 0.01 to 30 wt. %, based on the total weight of epoxy-functional organosilicon compound D.

According to a variant of the present invention, the present curable silicone composition comprises, in addition to the components A and B, or in place of the components A and B, at least one organosilicon compound comprising, per molecule, at least two alkenyl or alkynyl groups bonded to silicon atoms and at least two hydrogen atoms bonded to silicon atoms.

According to a variant of the present invention, the present curable silicone composition comprises, in addition to the components A and D, or in place of the components A and D, at least one organosilicon compound comprising, per molecule, at least two alkenyl or alkynyl groups bonded to silicon atoms and at least one epoxy function.

According to a variant of the present invention, the present curable silicone composition comprises, in addition to the components B and D, or in place of the components B and D, at least one organosilicon compound comprising, per molecule, at least two hydrogen atoms bonded to silicon atoms and at least one epoxy function.

According to a variant of the present invention, the present curable silicone composition comprises, in addition to the components A, B and D, or in place of the components A, B and D, at least one organosilicon compound comprising, per molecule, at least two alkenyl or alkynyl groups bonded to silicon atoms, at least two hydrogen atoms bonded to silicon atoms and at least one epoxy function.

As an example of the cationic photoinitiator E, mention may be made of: a Brönsted acid, such as onium salt (for example, diaryliodonium salt, aryldiazonium salt, alkoxypyridinium salt, triarylsulfonium salt and sulfonium salt), or a Lewis acid, such as organometallic salt (essentially ferrocenium salt).

Preferably, the cationic photoinitiator E used in the present invention is onium salt such as diaryliodonium salt, aryldiazonium salt, alkoxypyridinium salt, triarylsulfonium salt and sulfonium salt, more preferably diaryliodonium salt.

According to a preferred embodiment, the cationic photoinitiator E is an iodonium borate having, for its cationic part at the level of its aromatic nuclei, alkyl radical groups having from 10 to 30 carbon atoms, which is used in combination with a hydrogen donor chosen from a Guerbet alcohol, such that there are no longer any problems linked to the presence of an unpleasant odor perceived by users and thus avoiding the setting up of expensive technical solutions in order to solve this problem of olfactory nuisance.

According to a preferred embodiment, the iodonium salt has the formula (E1) below:

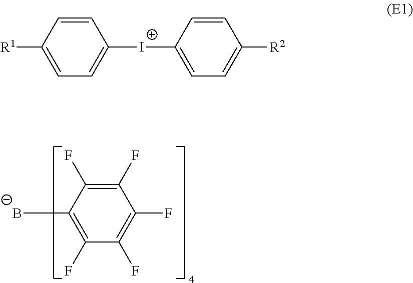

wherein:
the symbols R¹ and R² are identical or different, and each represent a linear or branched alkyl radical having from 10 to 30 carbon atoms and preferably from 10 to 20 carbon atoms and even more preferably from 10 to 15 carbon atoms.

According to a further preferred embodiment, the iodonium salts are chosen from the following structures:

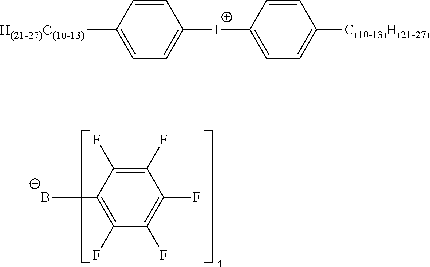

According to a preferred embodiment, the Guerbet alcohol has the formula below:

R⁴—CH(CH₂OH)—R⁵

wherein:
the symbols R⁴ and R⁵ are identical or different, and each represent an alkyl radical having from 4 to 12 carbon atoms, and the total number of carbon atoms of said Guerbet alcohol is from 10 to 20 carbon atoms.

The present curable silicone composition optionally comprises at least one filler and/or at least one silicone resin F.

The filler is preferably mineral filler. It may especially be siliceous. When it is a siliceous material, it may act as a reinforcing or semi-reinforcing filler. The reinforcing siliceous filler is chosen from colloidal silica, powder of fumed silica and of precipitated silica, or a mixture thereof. The powder has a mean particle size generally less than 0.1 μm (micrometers) and a BET specific surface area of greater than 30 m²/g, preferably between 30 and 350 m²/g. The silica may be incorporated in unmodified form or after having been treated with organosilicon compounds usually used for this purpose. Among these compounds are methylpolysiloxanes such as hexamethyldisiloxane, octamethylcyclotetrasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane.

The semi-reinforcing siliceous filler such as diatomaceous earth or ground quartz may also be used. As regards the non-siliceous mineral material, it may be included as semi-reinforcing or bulking mineral filler. Examples of the non-siliceous filler that may be used, alone or as a mixture, are carbon black, titanium dioxide, aluminum oxide, hydrated alumina, expanded vermiculite, non-expanded vermiculite, calcium carbonate optionally surface-treated with fatty acids, zinc oxide, mica, talc, iron oxide, barium sulfate and slaked lime. It is within the capability of the person skilled in the art to choose the particle size and the BET surface area of these fillers according to the actual demands.

Preferably, silica is used.

Advantageously, the filler is used in an amount of between 0.01% and 90%, preferably between 0.1 and 80%, more preferably between 0.5% and 50% by weight, relative to all the components of the composition.

According to a preferred embodiment, the present curable silicone composition may comprise at least one silicone resin. These silicone resins may be branched organopolysiloxane polymers which are well known and which are available commercially. They have, per molecule, at least two different units chosen from those of formula R′″SiO_{1/2} (M unit), R′″₂SiO_{2/2} (D unit), R′″SiO_{3/2} (T unit) and SiO_{4/2} (Q unit) with at least one of the units being a unit T or Q. The R′″ radicals are identical or different and are chosen from linear or branched alkyl radicals or vinyl, phenyl or 3,3,3-trifluoropropyl radicals. Preferably, the alkyl radicals have from 1 to 6 carbon atoms inclusive. More particularly, mention may be made, as examples of the alkyl radicals, of methyl, ethyl, isopropyl, tert-butyl and n-hexyl radicals. These resins are preferably vinylated or epoxidized and, in this case, have a weight content of vinyl or epoxy group of between 0.01 wt % and 20 wt %, based on the total weight of resin. These resins may also be the resins having hydrosilyl functions (SiH). Examples of the silicone resins that may be mentioned include MQ resins, MDQ resins, TD resins MDT resins, MD^{Vi}Q resins, MD^{Vi}TQ resins, MM^{Vi}Q resins, MM^{Vi}TQ resins and MM^{Vi}DD^{Vi}Q resins.

Advantageously, the silicone resin is used in an amount of 0.01% and 90%, preferably between 0.1 and 80%, more preferably between 0.5% and 50% by weight, relative to all the components of the composition.

The present curable silicone composition optionally comprises at least one hydrosilylation inhibitor G. Preferably, the hydrosilylation inhibitor G is chosen from α-acetylenic alcohols, α,α′-acetylenic diesters, conjugated ene-yne compounds, α-acetylenic ketones, acrylonitriles, maleates and fumarates, and mixtures thereof. These compounds capable of acting as hydrosilylation inhibitor are well known to the person skilled in the art. They may be used alone or as mixtures.

An inhibitor G which is an α-acetylenic alcohol that is useful according to the invention may be chosen from the group constituted by the following compounds: 1-ethynyl-1-cyclopentanol; 1-ethynyl-1-cyclohexanol (also known as ECH); 1-ethynyl-1-cycloheptanol; 1-ethynyl-1-cyclooctanol; 3-methyl-1-butyn-3-ol (also known as MBT); 3-methyl-1-pentyn-3-ol; 3-methyl-1-hexyn-3-ol; 3-methyl-1-heptyn-3-ol; 3-methyl-1-octyn-3-ol; 3-methyl-1-nonyn-3-ol; 3-methyl-1-decyn-3-ol; 3-methyl-1-dodecyn-3-ol; 3-methyl-1-pentadecyn-3-ol; 3-ethyl-1-pentyn-3-ol; 3-ethyl-1-hexyn-3-ol; 3-ethyl-1-heptyn-3-ol; 3,5-dimethyl-1-hexyn-3-ol; 3-isobutyl-5-methyl-1-hexyn-3-ol; 3,4,4-trimethyl-1-pentyn-3-ol; 3-ethyl-5-methyl-1-heptyn-3-ol; 3,6-diethyl-1-nonyn-3-ol; 3,7,11-trimethyl-1-dodecyn-3-ol (also known as TMDDO); 1,1-diphenyl-2-propyn-1-ol; 3-butyn-2-ol; 1-pentyn-3-ol; 1-hexyn-3-ol; 1-heptyn-3-ol; 5-methyl-1-hexyn-3-ol; 4-ethyl-1-octyn-3-ol and 9-ethynyl-9-fluorenol.

An inhibitor G which is an α,α′-acetylenic diester that is useful according to the invention may be chosen from the group constituted by the following compounds: dimethyl acetylenedicarboxylate (DMAD), diethyl acetylenedicarboxylate, tert-butyl acetylenedicarboxylate and bis(trimethylsilyl) acetylenedicarboxylate.

An inhibitor G which is a conjugated ene-yne compound that is useful according to the invention may be 1-ethynyl-1-cyclohexene.

An inhibitor G which is an α-acetylenic ketone that is useful according to the invention may be chosen from the group constituted by the following compounds: 1-octyn-3-one, 8-chloro-1-octyn-3-one; 8-bromo-1-octyn-3-one; 4,4-dimethyl-1-octyn-3-one; 7-chloro-1-heptyn-3-one; 1-hexyn-3-one; 1-pentyn-3-one; 4-methyl-1-pentyn-3-one; 4,4-dimethyl-1-pentyn-3-one; 1-cyclohexyl-1-propyn-3-one; benzoacetylene and o-chlorobenzoyl-acetylene.

An inhibitor G which is an acrylonitrile that is useful according to the invention may be chosen from the group constituted by the following compounds: acrylonitrile; methacrylonitrile; 2-chloroacrylonitryl; crotononitrile and cinnamonitrile.

An inhibitor G which is a maleate or a fumarate that is useful according to the invention may be chosen from the group constituted by diethyl fumarate, diethyl maleate, diallyl fumarate, diallyl maleate and bis(methoxyisopropyl) maleate.

The inhibitor G is preferably chosen from α-acetylenic alcohol, more preferably chosen from 1-ethynyl-1-cyclohexanol (ECH).

According to a preferred embodiment, the present curable silicone composition may comprise at least one photosensitizer H. The photosensitizer is chosen from molecules which absorb wavelengths different from those absorbed by the photoinitiator in order to thus make it possible to extend their spectral sensitivity. Its mode of action is more commonly known as “photosensitization” which consists of an energy transfer from the excited photosensitizer to the photoinitiator. Thus, the photosensitizer increases the fraction of light absorbed by the initiator and therefore the photolysis yield. Thus, a greater amount of reactive species is generated and, consequently, the polymerization is more rapid. There is a large number of photosensitizers well known to the person skilled in the art.

As an example of the photosensitizer H, mention may be made of: anthracene, pyrene, phenothiazine, Michler's ketone, xanthones, thioxanthones, benzophenone, acetophenone, carbazole derivatives, fluorenone, anthraquinone, camphorquinone or acylphosphine oxides.

As another example of the photosensitizer, mention may be made of: 4,4′-dimethoxybenzoin; phenanthrenequinone; 2 ethylanthraquinone; 2-methylanthraquinone; 1,8-dihydroxyanthraquinone; dibenzoyl peroxide; 2,2-dimethoxy-2-phenylacetophenone; benzoin; 2 hydroxy-2-methylpropiophenone; benzaldehyde; 4 (2-hydroxyethoxy)phenyl(2-hydroxy-2-methylpropyl) ketone; benzoylacetone;

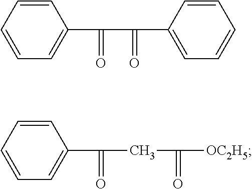 [SMILES: O=C(C(=O)c1ccccc1)c1ccccc1 ; CCOC(=O)CC(=O)c1ccccc1]

2-isopropylthioxanthone; 1-chloro-4-propoxythio-xanthone; 4-isopropylthioxanthone; 2,4-diethyl thioxanthone; cam phorquinone; and a mixture thereof.

The present curable silicone composition may optionally comprise at least one other auxiliary agent or additive I so long as they do not interfere with the curing mechanisms or adversely affect the target properties. Said other auxiliary agent or additive is chosen as a function of the applications in which said compositions are used and of the desired properties.

According to a preferred embodiment, the present curable silicone composition may comprises at least one adhesion promoter, for example, organosilicon compounds bearing both one or more hydrolyzable groups bonded to the silicon atom and one or more organic groups chosen from the group of (meth)acrylate, epoxy, and alkenyl radicals, preferably chosen from group constituted by the following compounds, taken alone or as a mixture: vinyltrimethoxysilane (VTMO), 3-glycidoxypropyltrimethoxysilane (GLYMO), methacryloxypropyltrimethoxysilane (MEMO).

According to another preferred embodiment, the present curable silicone composition may comprise at least one polyorganosiloxane simultaneously having epoxy group and SiH or vinyl group, so as to act as a bridge linking between the system containing the epoxy group and the system containing the SiH group.

According to the practical applications and/or demands, the present curable silicone composition may further comprise various types of additives I, used alone or as a mixture, such as pigments, delustrants, matting agents, heat and/or light stabilizers, antistatic agents, flame retardants, antibacterial agent, antifungal agent, thixotropic agent, photocuring inhibitor or retardant and so on.

In quantitative terms, the present curable silicone composition may have proportions that are standard in the technical field under consideration, given that the intended application must also be taken into account.

According to a preferred embodiment, the present curable silicone composition may comprise from 1 to 90 parts by weight, preferably from 5 to 80 parts by weight, of the organopolysiloxane A.

It should be understood that the total amount of the composition is 100 parts by weight.

Concerning the amount of the organohydrogenopolysiloxane B, it can be determined based on the mole ratio of the hydrogen atoms bonded to silicon atoms in the organohydrogenopolysiloxane B to the alkenyl or alkynyl groups bonded to silicon atoms in the organopolysiloxane A and on the amount of the organopolysiloxane A.

According to a preferred embodiment, the present curable silicone composition may comprise from 0.01 to 10 000 ppm, preferably from 0.1 to 1 000 ppm, of the hydrosilylation catalyst C.

Concerning the amount of the epoxy-functional organosilicon compound D, it can be determined based on the weight ratio between the organopolysiloxane A and the epoxy-functional organosilicon compound D and on the amount of the organopolysiloxane A.

According to a preferred embodiment, in the present curable silicone composition, the weight ratio between the organopolysiloxane A and the epoxy-functional organosilicon compound D is between 0.001 to 50, preferably between 0.1 to 40, more preferably between 0.1 to 30.

Concerning the amount of the cationic photoinitiator E, it can be determined based on the weight ratio between the cationic photoinitiator E and the epoxy-functional organosilicon compound D and on the amount of the epoxy-functional organosilicon compound D.

According to a preferred embodiment, in the present curable silicone composition, the weight ratio between the photoinitiator E and the epoxy-functional organosilicon compound D is from 0.001 to 0.1, preferably from 0.001 to 0.05, more preferably from 0.005 to 0.03.

For example, the present curable silicone composition may comprise from 0.001 to 10 parts by weight, preferably from 0.005 to 5 parts by weight, of the hydrosilylation inhibitor G.

The present curable silicone composition may have a dynamic viscosity at 25° C. of between 1 mPa·s and 3 000 000 mPa·s, preferably between 10 mPa·s and 1 000 000 mPa·s, and more preferably between 100 mPa·s and 500 000 mPa·s.

The present curable silicone composition may be prepared according to the common methods known to the person skilled in the art. For example, the present curable silicone composition may be prepared by mixing the various components.

The present curable silicone composition may be managed in one or two-part systems.

Another object of the invention concerns a three-dimensional (3D) printed article formed in accordance with the method of the invention as described above.

Another object of the invention concerns the use of the curable silicone composition according to the invention and as described above or the three-dimensional (3D) printed article according to the invention in electronics application or in 3D printing.

### DESCRIPTION OF THE FIGURES

FIG. 1 shows the transparency results of the products obtained after curing of the compositions according to three examples of the invention.

### MODE OF CARRYING OUT THE INVENTION

Other advantages and features of the present invention will appear on reading the following examples that are given by way of illustration and that are in no way limiting.

### EXAMPLES

Raw materials used in the examples are listed in the following table 1:

TABLE 1

| Raw materials | Chemical description or structure |
|---|---|
| A-1 | Vinyl terminated Polydimethylsiloxane, viscosity: 1500 mPa · s, vinyl content: 0.26 wt % |
| A-2 | Vinyl terminated Polydimethylsiloxane, viscosity: 100000 mPa · s, vinyl content: 0.08 wt % |
| A-3 | Vinyl terminated Polydimethylsiloxane, viscosity: 60000 mPa · s, vinyl content: 0.08 wt % |
| A-4 | Vinyl terminated Polydimethylsiloxane, viscosity: 3500 mPa · s, vinyl content: 0.2 wt % |
| B-1 | Poly(methylhydrogeno)(dimethyl)siloxane with end-chain (α/ω) SiH groups, |
| | viscosity: 160 mPa · s, SiH content: 0.8 wt % |
| B-2 | Poly(methylhydrogeno)(dimethyl)siloxane with SiH groups in-chain and end-chain (α/ω), |
| | viscosity: 25 mPa · s, SiH content: 20 wt % |
| B-3 | Poly(methylhydrogeno)(dimethyl)siloxane with SiH groups in-chain and end-chain (α/ω), |
| | viscosity: 300 mPa · s, SiH content: 4.75 wt % |
| C-1 | Pt catalyst: Platinum(0)-1,3-divinyl-1,1,3,3-tetramethyldisiloxane (Pt content: 10 wt %) |
| D-1 | Epoxy-containing Polydimethylsiloxane, viscosity: 5500 mPa · s, epoxy content: 2.7 wt % |
| | 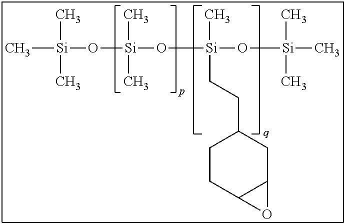 |
| | in which p = 310; q = 4.5 |
| D-2 | Epoxy-containing Polydimethylsiloxane, viscosity: 45 mPa · s, epoxy content: 12.65 wt % |
| | 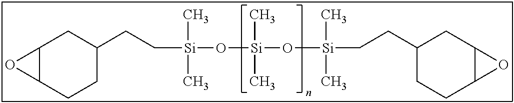 |
| | in which n = 22 |
| D-3 | Epoxy-containing Polydimethylsiloxane, viscosity: 465 mPa · s, epoxy content: 16.1 wt % |
| | 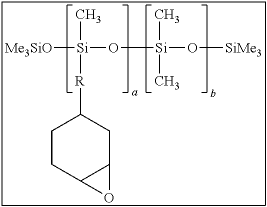 |
| | in which a = 11; b = 85, Me = methyl |
| D-4 | Epoxy-containing Polydimethylsiloxane, viscosity: 350 mPa · s, epoxy content: 11.25 wt % |
| | 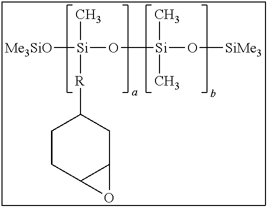 |
| | in which a = 7.5; b = 80, Me = methyl |
| D-5 | Epoxy-containing Polydimethylsiloxane, viscosity: 765 mPa · s, epoxy content: 2.65 wt % |
| | 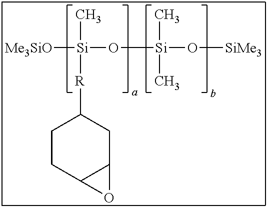 |
| | in which a = 220; b = 2.5, Me = methyl |
| E-1 | iodonium borate salt diluted in Guerbet alcohol, CAS NO.: 1115251-57-4 |
| E-2 | Diphenyliodonium hexafluorophosphate CAS NO.: 58109-40-3 |
| F-1 | Treated silica, CAS NO: 68988-89-6 |
| F-2 | Alumina |
| F-3 | Vinyl-containing siloxane resin MD^{Vi}Q, vinyl content: 1.88 wt % |
| G-1 | Ethynylcyclohexanol, CAS NO.: 78-27-3 |
| H-1 | Photosensitizer: mixture of 2-isopropylthioxanthone (CAS NO.: 5495-84-1) and 4- |
| | isopropylthioxanthone, (CAS NO.: 83846-86-0) |
| I-1 | (CAS NO.: 83846-86-0) |
| | Vinyltrimethoxysilane |
| | CAS NO.: 2768-02-7 |
| I-2 | (3-Glycidyloxypropyl) |
| | Trimethoxysilane |
| | CAS NO.: 2530-83-8 |
| I-3 | the reaction product obtained by condensation of the following two materials: |
| | 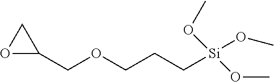 |
| | 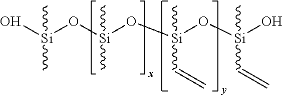 |
| | in which x = 0~10000, and y = 0~10000. |
| I-4 | Polydisiloxane with epoxy group and SiH |
| | viscosity: 14 mPa · s, |
| | SiH content: 38.5 wt % |
| | CAS NO.: 1337988-64-3 |

TABLE 2-a
Formulas and test results of curable silicone compositions

| | | | | | | | | |
|---|---|---|---|---|---|---|---|---|
| example 1 | example 2 | example 3 | example 4 | example 5 | example 6 | example 7 | example 8 | example 9 |

Raw materials

| | | | | | | | | | |
|---|---|---|---|---|---|---|---|---|---|
| A-1 | 32.26 | 80.6 | 43.98 | 43.95 | 44.68 | 35.66 | 23.94 | 83.79 | 74.7 |
| A-2 | 0 | 0 | 0 | 0 | 0 | 0 | 0 | 0 | 0 |
| B-1 | 4.61 | 4.24 | 3.5 | 3.5 | 2 | 2.47 | 1.77 | 3.53 | 3.53 |
| B-2 | 0 | 0 | 1.5 | 1.5 | 0 | 1.06 | 0.76 | 1.51 | 1.51 |
| B-3 | 2.76 | 1.81 | 0 | 0 | 2 | 0 | 0 | 0 | 0 |
| C-1 | 0.0092 | 0.016 | 0.016 | 0.016 | 0.016 | 0.016 | 0.016 | 0.016 | 0.016 |
| D-1 | 46.08 | 3 | 40 | 39.99 | 40 | 50 | 62.59 | 11 | 20 |
| D-2 | 0 | 0 | 0 | 0 | 0 | 0 | 0 | 0 | 0 |
| D-3 | 0 | 0 | 0 | 0 | 0 | 0 | 0 | 0 | 0 |
| D-4 | 0 | 0 | 0 | 0 | 0 | 0 | 0 | 0 | 0 |
| D-5 | 0 | 0 | 0 | 0 | 0 | 0 | 0 | 0 | 0 |
| E-1 | 0.46 | 0.03 | 0.4 | 0.4 | 0.4 | 0.5 | 0.63 | 0.11 | 0.2 |
| F-1 | 13.82 | 10.26 | 10.17 | 10.16 | 10.17 | 10.26 | 10.26 | 0 | 0 |
| G-1 | 0.0092 | 0.04 | 0.04 | 0.04 | 0.04 | 0.04 | 0.04 | 0.04 | 0.04 |
| H-1 | 0 | 0 | 0 | 0.05 | 0 | 0 | 0 | 0 | 0 |
| I-1 | 0 | 0 | 0.2 | 0.2 | 0 | 0 | 0 | 0 | 0 |
| I-2 | 0 | 0 | 0.2 | 0.2 | 0 | 0 | 0 | 0 | 0 |
| I-3 | 0 | 0 | 0 | 0 | 0.2 | 0 | 0 | 0 | 0 |
| W | 0 | 0 | 0 | 0 | 0.5 | 0 | 0 | 0 | 0 |
| TOTAL | 100 | 100 | 100 | 100 | 100 | 100 | 100 | 100 | 100 |
| SiH/Si-alkenyl | 1.27 | 1.54 | 1.7 | 1.66 | 1.9 | 1.77 | 1.68 | 1.41 | 1.8 |
| (mole ratio) | | | | | | | | | |
| Alkenyl-sioxane/ | 0.7 | 26.8 | 1.1 | 1.1 | 1.1 | 0.71 | 0.38 | 7.6 | 3.7 |
| epoxy - | | | | | | | | | |
| siloxane (weight | | | | | | | | | |
| ratio) | | | | | | | | | |

Test results

| | | | | | | | | | | |
|---|---|---|---|---|---|---|---|---|---|---|
| Viscosity, | 25° C., | 89000 (6#, | 26000 (6#, | 22900 (6#, | 36000 (6#, | 25000 (6#, | 24500 (6#, | 18800 (6#, | 1700 (3#, | 2000 (3#, |
| mPa · s | | 20 rpm) | 20 rpm) | 20 rpm) | 10 rpm) | 20 rpm) | 20 rpm) | 20 rpm) | 20 rpm) | 20 rpm) |
| Status after | UV curing, | shape | shape | shape | shape | shape | shape | shape | shape | shape |
| UV curing | 30 sec | figuration | figuration | figuration | figuration | figuration | figuration | figuration | figuration | figuration |
| Hardness, | | 26 | NA | 15 | 20 | 15 | 20 | 31 | NA | NA |
| Shore A | | | | | | | | | | |
| tear | UV curing | 0.6 | NA | 0.58 | 0.92 | 0.51 | 0.59 | 0.87 | NA | NA |
| strength, | 30 sec + | | | | | | | | | |
| N/mm | 80° C. × | | | | | | | | | |
| Tensile | 30 min | 0.8 | NA | 0.5 | 0.37 | 0.54 | 0.51 | 0.41 | NA | NA |
| strength, | | | | | | | | | | |
| Mpa | | | | | | | | | | |
| Elongation | | | | | | | | | | |
| at | | 70 | NA | 81 | 63 | 64 | 62 | 41 | NA | NA |
| break, % | | | | | | | | | | |
| Bath life | | 3 | | 160 | >360 | 170 | | | | |
| stability at | | | | | | | | | | |
| 20° C. | | | | | | | | | | |
| (hours) | | | | | | | | | | |
| Bath life | | 2 | | 50 | 94 | 51 | | | | |
| stability at | | | | | | | | | | |
| 30° C. | | | | | | | | | | |
| (hours) | | | | | | | | | | |

| | | example 10 | example 11 | example 12 | example 13 | example 14 | example 15 | example 16 |
|---|---|---|---|---|---|---|---|---|
| Raw materials | | | | | | | | |
| A-1 | | 45.92 | 17.88 | 23.94 | 35.66 | 35.66 | 35.66 | 35.66 |
| A-2 | | 0 | 0 | 11.72 | 0 | 0 | 0 | 0 |
| B-1 | | 2.47 | 0.88 | 2.47 | 2.47 | 2.47 | 2.47 | 2.47 |
| B-2 | | 1.06 | 0.38 | 1.06 | 1.06 | 1.06 | 1.06 | 1.06 |
| B-3 | | 0 | 0 | 0 | 0 | 0 | 0 | 0 |
| C-1 | | 0.016 | 0.016 | 0.016 | 0.016 | 0.016 | 0.016 | 0.016 |
| D-1 | | 50 | 80 | 50 | 0 | 0 | 0 | 0 |
| D-2 | | 0 | 0 | 0 | 50 | 0 | 0 | 0 |
| D-3 | | 0 | 0 | 0 | 0 | 50 | 0 | 0 |
| D-4 | | 0 | 0 | 0 | 0 | 0 | 50 | 0 |
| D-5 | | 0 | 0 | 0 | 0 | 0 | 0 | 50 |
| E-1 | | 0.5 | 0.8 | 0.5 | 0.5 | 0.5 | 0.5 | 0.5 |
| F-1 | | 0 | 0 | 10.26 | 10.26 | 10.26 | 10.26 | 10.26 |
| G-1 | | 0.04 | 0.04 | 0.04 | 0.04 | 0.04 | 0.04 | 0.04 |
| H-1 | | 0 | 0 | 0 | 0 | 0 | 0 | 0 |
| I-1 | | 0 | 0 | 0 | 0 | 0 | 0 | 0 |
| I-2 | | 0 | 0 | 0 | 0 | 0 | 0 | 0 |
| I-3 | | 0 | 0 | 0 | 0 | 0 | 0 | 0 |
| W | | 0 | 0 | 0 | 0 | 0 | 0 | 0 |
| TOTAL | | 100 | 100 | 100 | 100 | 100 | 100 | 100 |
| SiH/Si-alkenyl | | 1.79 | 1.65 | 1.77 | 1.77 | 1.77 | 1.77 | 1.77 |
| (mole ratio) | | | | | | | | |
| Alkenyl-sioxane/ | | 0.92 | 0.22 | 0.71 | 0.71 | 0.71 | 0.71 | 0.71 |
| epoxy - | | | | | | | | |
| siloxane (weight | | | | | | | | |
| ratio) | | | | | | | | |
| Test results | | | | | | | | |
| Viscosity, | 25° C., | 3150 (3#, | 4900 (3#, | 50000 (6#, | 8600 (5#, | 51500 (6#, | 6190 (4#, | 29200 (6#, |
| mPa · s | | 20 rpm) | 20 rpm) | 10 rpm) | 20 rpm) | 10 rpm) | 20 rpm) | 20 rpm) |
| Status after | UV curing, | shape | shape | shape | shape | shape | shape | shape |
| UV curing | 30 sec | figuration | figuration | figuration | figuration | figuration | figuration | figuration |
| Hardness, | | 11 | 24 | 25 | NA | NA | 37 | 20 |
| Shore A | | | | | | | | |
| tear | UV curing | 0.49 | 0.56 | 0.9 | NA | NA | 1.9 | 2.6 |
| strength, | 30 sec + | | | | | | | |
| N/mm | 80° C. × | | | | | | | |
| Tensile | 30 min | 0.056 | 0.38 | 0.48 | NA | NA | 0.24 | 0.21 |
| strength, | | | | | | | | |
| Mpa | | | | | | | | |
| Elongation | | | | 60 | NA | NA | 73 | |
| at | | 50 | 56 | | | | | 55 |
| break, % | | | | | | | | |
| Bath life | | | | | | | | |
| stability at | | | | | | | | |
| 20° C. | | | | | | | | |
| (hours) | | | | | | | | |
| Bath life | | | | | | | | |
| stability at | | | | | | | | |
| 30° C. | | | | | | | | |
| (hours) | | | | | | | | |

TABLE 2-b
Formulas and test results of curable silicone compositions

| | | | | | |
|---|---|---|---|---|---|
| example 17 | example 18 | example 19 | example 20 | example 21 | example 22 |

Raw materials

| | | | | | | |
|---|---|---|---|---|---|---|
| A-1 | 34.4 | 21.66 | 45.66 | 11.72 | 0 | 81.88 |
| A-3 | 0 | 0 | 0 | 17.98 | 0 | 0 |
| A-4 | 0 | 0 | 0 | 0 | 11.45 | 0 |
| B-1 | 2.47 | 2.47 | 2.47 | 5.44 | 1.2 | 2.45 |
| B-2 | 1.06 | 1.06 | 1.06 | 2.33 | 2.44 | 1.98 |
| B-3 | 0 | 0 | 0 | 0 | 0 | 0 |
| C-1 | 0.016 | 0.016 | 0.016 | 0.016 | 0.016 | 0.016 |
| D-1 | 50 | 50 | 40 | 50 | 50 | 0 |
| E-1 | 0 | 0.5 | 0.5 | 0.5 | 0.5 | 0.50 |
| E-2 | 0.5 | 0 | 0 | 0 | 0 | 0 |
| F-1 | 10.26 | 4.26 | 10.26 | 0 | 0 | 13.14 |
| F-2 | 0 | 20 | 0 | 0 | 0 | 0 |
| F-3 | 0 | 0 | 0 | 11.99 | 34.35 | 0 |
| G-1 | 0.04 | 0.04 | 0.04 | 0.04 | 0.04 | 0.04 |
| TOTAL | 100 | 100 | 100 | 100 | 100 | 100 |
| SiH/Si-alkenyl | 1.77 | 3.14 | 1.46 | 1.75 | 1.69 | 1.55 |
| (mole ratio) | | | | | | |
| Alkenyl-siloxane/ | 0.69 | 0.43 | 1.14 | 0.83 | 0.92 | |
| epoxy - | | | | | | |
| siloxane (weight | | | | | | |
| ratio) | | | | | | |

Test results

| | | | | | | | |
|---|---|---|---|---|---|---|---|
| Viscosity, | 25° C., | 25000 | 10250 | 28000 | 7320 | 5100 | |
| mPa · s | | (6#, | (6#, | (6#, | (4#, | (4#, | |
| | | 20 rpm) | 20 rpm) | 20 rpm) | 20 rpm) | 20 rpm) | |
| Status after | UV curing, | Non-shape | shape | shape | shape | shape | No shape |
| UV curing | 30 sec | figuration | figuration | figuration | figuration | figuration | figuration |
| Hardness, | UV curing, | shape | NA | NA | NA | NA | No shape |
| Shore A | 45 sec | figuration | | | | | figuration |
| | UV curing, | NA | NA | 13 | 30 shore.OO | 1 | |
| | 30 sec | | | | | | |
| Hardness, | | NA | 31 | 17 | 37 shore.OO | 3 | |
| Shore A | | | | | | | |
| tear | UV curing | NA | 0.72 | 0.45 | 0.5 | 0.51 | |
| strength, | 30 sec + | | | | | | |
| N/mm | 80° C. × | | | | | | |
| Tensile | | NA | 0.56 | 0.36 | 0.17 | 0.077 | |
| strength, | 30 min | | | | | | |
| Mpa | | | | | | | |
| Elongation at | | NA | 57 | 61 | 48 | 62 | |
| break, % | | | | | | | |
| Rate of | | | | 24% | 19% | 67% | |
| hardness | | | | | | | |
| change | | | | | | | |

NA: mechanical property could not be tested.

In the table 2-b, hardnesses of samples are obtained by using different durometers such as Shore.A or Shore.OO. Conversion relationship of the two durometers can be seen in table 3 according to the standard ASTM D 2240 and DIN 53505.

In the table 2-a and 2-b, “shape figuration” means that after UV curing, the composition loses its fluidity due to the reaction, and thus be in the state of a gel or an elastomer.

TABLE 3
hardness conversion table

| Shore.OO | Shore.A |
|---|---|
| 45 | 5 |
| 55 | 10 |
| 62 | 15 |
| 70 | 20 |
| 76 | 25 |
| 80 | 30 |
| 83 | 35 |

### Examples 1-2 are Prepared According to the Following Procedure

46.08 parts of epoxy grafted polydimethylsiloxane oil D-1, with a viscosity equal to 5500 mPa·s and comprising 2.7% by weight of epoxy groups, are added to 32.26 parts of vinyl terminated polydimethylsiloxane A-1 and 13.82 parts of F-1. The 0.0092 parts of inhibitor G-1 are added and then mixed sufficiently. 4.61 parts of a hydrogen-terminated polysiloxane oil B-1 and 2.76 parts of a hydrosiloxane oil B-3 are added and mixed, following with 0.46 parts of E-1 and 0.0092 parts of C-1 to obtain curable silicone composition in example 1. Example 2 is similarly prepared according to the above process via adjusting ratio of different raw materials.

### Example 3 is Prepared According to the Following Procedure

40.17 parts of epoxy grafted polydimethylsiloxane oil D-1, with a viscosity equal to 5500 mPa·s and comprising 2.7% by weight of epoxy groups, are added to 44.15 parts of vinyl terminated polydimethylsiloxane A-1 and 10.21 parts of F-1. The 0.04 parts of inhibitor G-1 are added and then mixed sufficiently. 3.51 parts of a hydrogen-terminated polysiloxane oil B-1 and 1.5 parts of a hydrosiloxane oil B-2 are added and mixed, following with 0.2 parts of I-1 and 0.2 parts of I-2. Finally, and 0.016 parts of C-1 are added into polysilxoane mixture to obtain curable silicone composition in example 3.

### Example 4 is Prepared According to the Following Procedure

40.15 parts of epoxy grafted polydimethylsiloxane oil D-1, with a viscosity equal to 5500 mPa·s and comprising 2.7% by weight of epoxy groups, are added to 44.13 parts of vinyl terminated polydimethylsiloxane A-1 and 10.21 parts of F-1. The 0.04 parts of inhibitor G-1 are added and then mixed sufficiently. 3.51 parts of a hydrogen-terminated polysiloxane oil B-1 and 1.5 parts of a hydrosiloxane oil B-2 are added and mixed, following with 0.2 parts of I-1 and 0.2 parts of I-2. Finally, 0.05 parts of H-1 and 0.016 parts of C-1 are added into polysilxoane mixture to obtain curable silicone composition in example 4.

### Example 5 is Prepared According to the Following Procedure

40 parts of epoxy grafted polydimethylsiloxane oil D-1, with a viscosity equal to 5500 mPa·s and comprising 2.7% by weight of epoxy groups, are added to 44.68 parts of vinyl terminated polydimethylsiloxane A-1 and 10.17 parts of F-1. The 0.04 parts of inhibitor G-1 are added and then mixed sufficiently. 2 parts of a hydrogen-terminated polysiloxane oil B-1 and 2 parts of a hydrosiloxane oil B-3 are added and mixed, following with 0.2 parts of I-3 and 0.5 parts of I-4. Finally, 0.4 parts of E-1, and 0.016 parts of C-1 are added into polysilxoane mixture to obtain curable silicone composition in example 5.

### Examples 6-7 are Prepared According to the Following Procedure

50 parts of epoxy grafted polydimethylsiloxane oil D-1, with a viscosity equal to 5500 mPa·s and comprising 2.7% by weight of epoxy groups, are added to 35.66 parts of vinyl terminated polydimethylsiloxane A-1 and 10.26 parts of F-1. The 0.04 parts of inhibitor G-1 are added and then mixed sufficiently. 2.47 parts of a hydrogen-terminated polysiloxane oil B-1 and 1.06 parts of a hydrosiloxane oil B-2 are added and mixed, following with 0.5 parts of E-1 and 0.016 parts of C-1 to obtain curable silicone composition in example 6. Example 7 is similarly prepared according to the above process via adjusting ratio of different raw materials.

### Examples 8-11 are Prepared According to the Following Procedure

11 parts of epoxy grafted polydimethylsiloxane oil D-1, with a viscosity equal to 5500 mPa·s and comprising 2.7% by weight of epoxy groups, are added to 83.79 parts of vinyl terminated polydimethylsiloxane A-1. The 0.04 parts of inhibitor G-1 are added and then mixed sufficiently. 3.53 parts of a hydrogen-terminated polysiloxane oil B-1 and 1.51 parts of a hydrosiloxane oil B-2 are added and mixed, following with 0.11 parts of E-1 and 0.016 parts of C-1 to obtain curable silicone composition in example 8. Examples 9-11 are similarly prepared according to the above process via adjusting ratio of different raw materials.

### Examples 12-16 are Prepared According to the Following Procedure

50 parts of epoxy grafted polydimethylsiloxane oil D-1, with a viscosity equal to 5500 mPa·s and comprising 2.7% by weight of epoxy groups, are added to 23.94 parts of vinyl terminated polydimethylsiloxane A-1, 11.72 parts of vinyl terminated polydimethylsiloxane A-2 and 10.26 parts of F-1. The 0.04 parts of inhibitor G-1 are added and then mixed sufficiently. 2.47 parts of a hydrogen-terminated polysiloxane oil B-1 and 1.06 parts of a hydrosiloxane oil B-2 are added and mixed, following with 0.5 parts of E-1 and 0.016 parts of C-1 to obtain curable silicone composition in example 12. Example 13-16 are similarly prepared according to the above process via adjusting ratio of different raw materials. Herein, in place of D-1 used in example 12, examples 13-16 respectively use D-2, D-3, D-4 and D-5 according to the ratios in the table 2-a.

### Example 17 is Prepared According to the Following Procedure

50 parts of epoxy grafted polydimethylsiloxane oil D-1, with a viscosity equal to 5500 mPa·s and comprising 2.7% by weight of epoxy groups, are added to 34.4 parts of vinyl terminated polydimethylsiloxane A-1 and 10.26 parts of F-1. The 0.04 parts of inhibitor G-1 are added and then mixed sufficiently. 2.47 parts of a hydrogen-terminated polysiloxane oil B-1 and 1.06 parts of a hydrosiloxane oil B-2 are added and mixed, following with 0.5 parts of E-2 and 0.016 parts of C-1 to obtain curable silicone composition in example 17.

### Example 18 is Prepared According to the Following Procedure

50 parts of epoxy grafted polydimethylsiloxane oil D-1, with a viscosity equal to 5500 mPa·s and comprising 2.7% by weight of epoxy groups, are added to 21.66 parts of vinyl terminated polydimethylsiloxane A-1, 4.26 parts of F-1 and 20 parts of F-2. 0.04 parts of inhibitor G-1 are added and then mixed sufficiently. 2.47 parts of a hydrogen-terminated polysiloxane oil B-1 and 1.06 parts of a hydrosiloxane oil B-2 are added and mixed, following with 0.5 parts of E-1 and 0.016 parts of C-1 to obtain curable silicone composition in example 18.

### Example 19 is Prepared According to the Following Procedure

40 parts of epoxy grafted polydimethylsiloxane oil D-1, with a viscosity equal to 5500 mPa·s and comprising 2.7% by weight of epoxy groups, are added to 45.66 parts of vinyl terminated polydimethylsiloxane A-1 and 10.26 parts of F-1. The 0.04 parts of inhibitor G-1 are added and then mixed sufficiently. 2.47 parts of a hydrogen-terminated polysiloxane oil B-1 and 1.06 parts of a hydrosiloxane oil B-2 are added and mixed, following with 0.5 parts of E-1 and 0.016 parts of C-1 to obtain curable silicone composition in example 19.

### Examples 20-21 are Prepared According to the Following Procedure

50 parts of epoxy grafted polydimethylsiloxane oil D-1, with a viscosity equal to 5500 mPa·s and comprising 2.7% by weight of epoxy groups, are added to 11.72 parts of vinyl terminated polydimethylsiloxane A-1, 17.98 parts of vinyl terminated polydimethylsiloxane A-3 and 11.99 parts of vinyl-containing silioxane resin F-3. The 0.04 parts of inhibitor G-1 are added and then mixed sufficiently. 5.44 parts of a hydrogen-terminated polysiloxane oil B-1 and 2.33 parts of a hydrosiloxane oil B-2 are added and mixed, following with 0.5 parts of E-1 and 0.016 parts of C-1 to obtain curable silicone composition in example 20. Example 21 are similarly prepared according to the above process via adjusting ratio of different raw materials in table 2-b.

### Examples 22 (Comparative Example) is Prepared According to the Following Procedure

81.88 parts of vinyl terminated polydimethylsiloxane A-1 are mixed with 13.14 parts of F-1. Then 0.04 parts of inhibitor G-1 are added and then mixed sufficiently. 2.45 parts of a hydrogen-terminated polysiloxane oil B-1 and 1.98 parts of a hydrosiloxane oil B-2 are added and mixed, following with 0.5 parts of E-1 and 0.016 parts of C-1 to obtain curable silicone composition.

### 3D Printing Process by Using the Present Curable Silicone Composition

The 3D printing process is carried out by using ULTIMAKER 2+ equipment (provided by the company Ultimaker) and a UV light source is added to the equipment. The distance between the UV light source and the printing head is about 30 cm. The composition of example 2 is used as the printing silicone material.

Printing process is as follows:

I. Loading the silicone material into an extruder;

II. Level adjusting the printing platform and setting printing parameters;

III. Starting printing under the UV light.

The sample is beamed by a UV Hg lamp, in which the parameters of the UV Hg lamp are as follows.

Light power: 120 w/cm 20 m/min,

| | | |
|---|---|---|
| UV-A: | 147.7 mJ/cm² | 1417.9 mw/cm² |
| UV-B: | 112.8 mJ/cm² | 1092.8 mw/cm² |
| UV-C: | 33.4 mJ/cm² | 321.9 mw/cm² |
| UV-V: | 192.7 mJ/cm² | 1840.7 mw/cm² |

When the sample according to the invention is beamed for 3 s, the sample loses fluidity and is rapidly formed. In contrast, Examples 3 & 4 which do not contain cationic photoinitiator do not allow to have a “shape figuration” which raise major issues when building complex shapes.

Every layer according to the invention can be formed and shape figuration can be achieved rapidly under UV light. After finishing the printing, the subsequent curing of the sample is carried out at 80° C. for 30 min to obtain the target 3D printing product.

As can be seen from the above, in the 3D printing process, the curable silicone composition is initiated by means of UV light to realize a fast-initial curing and then the subsequent curing continues to obtain the desired properties. Thus, the curable silicone composition is well suited for the 3D printing.

### Properties Assessments

The properties assessments on the curable silicone compositions according to the present invention are listed in the tables 2-a and 2-b.

Viscosity: The viscosity of the sample based on the curable silicone composition is measured at 25° C. according to ASTM D445. The details of measuring conditions are listed in the tables 2-a and 2-b, in which, for example, the expression “(6 #, 20 rpm)” means that the viscosity is measured at 20 rpm by using spindle number 6, and so on.

Hardness: The hardness of the cured sample based on the curable silicone composition is measured at 25° C. according to ASTM D2240. The details of the measuring conditions are listed in the tables 2-a and 2-b. The cured sample based on the curable silicone composition is obtained under UV irradiation for 30 s, following with subsequent curing at 80° C. for 30 min.

Tensile strength and Elongation at break: Tensile strength and elongation at break of the cured sample based on the curable silicone composition are measured at 25° C. according to ASTM D412. The details of the measuring conditions are listed in the tables 2-a and 2-b. The cured sample based on the curable silicone composition is obtained under UV irradiation for 30 s, following with subsequent curing at 80° C. for 30 min.

Tear strength: Tear strength of the cured sample based on the curable silicone composition is measured at 25° C. according to ASTM D642. The details of the measuring conditions are listed in the tables 2-a and 2-b. The cured sample based on the curable silicone composition is obtained under UV irradiation for 30 s, following with subsequent curing at 80° C. for 30 min.

Bath life: The sample based on the curable silicone composition is stored at 20° C. or 30° C., respectively, until the samples became gelation. The time of gelation is recorded.

the rate of hardness change: In the present invention, the rate of hardness change is defined as:

$$Rate of hardness change = \frac{hardness after the completion of the curing of the composition - hardness after UV initial curing of the composition}{hardness after the completion of the curing of the composition} \times 100 \%$$

in which the expression “hardness after the completion of the curing of the composition” refers to the hardness measured after the composition undergoes epoxy-related UV curing and hydrosilylation curing, and the expression “hardness after UV initial curing of the composition” refers to the hardness measured after the composition initially undergoes epoxy-related UV curing.

By way of example, the hardness after UV initial curing of the composition may be measured 30 seconds after the start of UV curing, and the hardness after the completion of the curing of the composition may be measured 1 hour after the start of curing the composition.

As can be seen from the tables 2-a and 2-b, the curable silicone composition according to the present invention allows obtaining fast shape figuration by epoxy-related photocuring and the comprehensive properties by hydrosilylation reaction, including desired mechanical properties such as tensile strength, elongation at break and tear strength. In comparison, the mechanical properties are generally poor if a silicone composition only involves an epoxy-related photocuring, as well known in the art.

The mechanical properties can be improved via introduction of a filler and/or silicone resin.

Also, I-3 or I-4, which simultaneously has epoxy group and SiH or vinyl group, can act as a bridge linking between the epoxy-related photocuring system and the hydrosilylation system and thus improve the properties of the composition.

Epoxy-containing polysiloxane plays an important role in the whole curing. Less Epoxy-containing polysiloxane will cause insufficient shape figuration after UV curing. Meanwhile, the photosensitizer also plays an important role in the final properties of some curable silicone compositions. Suitable content of photosensitizer is helpful for the present curable silicone system.

In addition, based on ratio of inhibitors and Pt catalyst, the samples with different bath life can be obtained to satisfy different demand of 3D printing.

In the examples 12-16, different vinyl-containing polysiloxane and epoxy-containing polysiloxane are added into the formulation. The results exhibit the fast shape figuration and the epoxy-related photocuring and the hydrosilylation curing can be obtained, which indicates different raw materials also can achieve the target of the invention. The example 12 and examples 15-16 exhibits good mechanical properties. The examples 13 and 14 give gel sample because of molecular structure and epoxy content of the epoxy-containing polysiloxane.

In the example 17, cationic photoinitiator E-2 is used, which indicates that different cationic photoinitiators can also offer enough energy to initiate cationic photopolymerization. In the example 18, alumina is added into the present composition involving epoxy-related photocuring and hydrosilylation curing. The results indicate that the addition of alumina has less negative effect on photopolymerization.

In the example 18-21, hardness of different curing phases are investigated, which shows the present curing system gives epoxy-related photocuring and hydrosilylation curing. The higher the rate of hardness change is, the less contribution of UV initial curing is.

In the example 22, without epoxy-containing polysiloxane, shape figuration cannot be observed after UV curing.

The present curable silicone compositions involving epoxy-related photocuring and hydrosilylation curing have been shown in the examples. Proper UV curing mechanism based on epoxy groups has little negative effect on the hydrosilylation reaction, which is very important for the curable system of the invention. The curable silicone compositions have several advantages, such as fast initial curing in combination with the further subsequent curing, such that the comprehensive mechanical properties can be obtained, which are especially suitable for 3D printing.

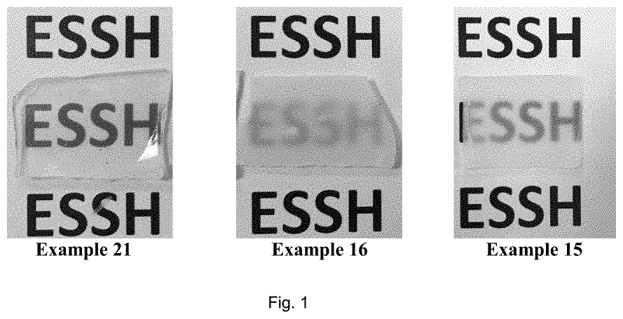

FIG. 1 shows the transparency results of the products obtained after curing of the compositions according to the examples 15, 16 and 21 of the invention. The thickness of the cured product is about 2-3mm. The transparencies of these products are evaluated visually. The results are expressed as scores, of which the score 5 represents that the product is completely transparent. The transparency scores of these examples as follows: Example 15 is 3, Example 16 is 2.5 and Example 21 is 4.

It can be seen that the transparencies of the products obtained from the curable silicone compositions of the invention are adjustable as required.

1. A method of producing a three-dimensional (3D) printed article, the method comprising the steps of:
(i) providing a curable silicone composition, comprising:
A. at least one organopolysiloxane comprising, per molecule, at least two alkenyl or alkynyl groups bonded to silicon atoms;
B. at least one organohydrogenopolysiloxane comprising, per molecule, at least two hydrogen atoms bonded to silicon atoms,
C. at least one hydrosilylation catalyst;
D. at least one epoxy-functional organosilicon compound;
E. at least one cationic photoinitiator;
F. optionally, at least one filler and/or at least one silicone resin;
G. optionally, at least one hydrosilylation inhibitor, and
H. optionally at least one photosensitizer,
(ii) printing said curable silicone composition with a 3D printer to form a printed composition,
(iii) photopolymerizing at least part of the total number of epoxy groups of the printed composition while printing to provide an at least partially solidified layer,
(iv) optionally, repeating one or more times steps (ii) and (iii) onto said at least partially solidified layer previously obtained until a desired shape is obtained, and
(iv) allowing hydrosilylation curing to continue until said at least partially solidified layer(s) becomes a solidified layer(s), and hence obtaining said 3D printed article.

2. The method according to claim 1, wherein the curable silicone composition comprises:
(a) in addition to the components A and B, or in place of the components A and B, at least one organosilicon compound comprising, per molecule, at least two alkenyl or alkynyl groups bonded to silicon atoms and at least two hydrogen atoms bonded to silicon atoms;
(b) in addition to the components A and D, or in place of the components A and D, at least one organosilicon compound comprising, per molecule, at least two alkenyl or alkynyl groups bonded to silicon atoms and at least one epoxy function;
(c) in addition to the components B and D, or in place of the components B and D, at least one organosilicon compound comprising, per molecule, at least two hydrogen atoms bonded to silicon atoms and at least one epoxy function; or
(d) in addition to the components A, B and D, or in place of the components A, B and D, at least one organosilicon compound comprising, per molecule, at least two alkenyl or alkynyl groups bonded to silicon atoms, at least two hydrogen atoms bonded to silicon atoms and at least one epoxy function.

3. The method according to claim 1, wherein the cationic photoinitiator E is a Brönsted acid or a Lewis acid.

4. The method according to claim 3, wherein the cationic photoinitiator E is an iodonium borate having, for its cationic part at the level of its aromatic nuclei, alkyl radical groups having from 10 to 30 carbon atoms, which is used in combination with a hydrogen donor chosen from a Guerbet alcohol.

5. The method according to claim 1, wherein the filler F is mineral filler.

6. The method according to claim 1, wherein the filler F is used in an amount from 0.01% to 90% by weight, relative to all the components of the composition.

7. The method according to claim 1, wherein the method employs the silicone resin in an amount from 0.01% to 90% by weight, relative to all the components of the composition.

8. The method according to claim 1, wherein the weight ratio of the organopolysiloxane A to the epoxy-functional organosilicon compound D is from 0.001 to 50.

9. The method according to claim 1, wherein the printing with the 3D printer is performed using an approach selected from the group consisting of Extrusion 3D printing, UV-Stereolithography (SLA), UV-Digital Light processing (DLP), Continuous Liquid Interface Production (CLIP), Inkjet Deposition and combinations thereof.

10. A three-dimensional (3D) printed article formed in accordance with the method of claim 1.

11. A method of a using a curable silicone composition in an electronics application, the method comprising employing the curable silicone composition according to claim 1 in the electronics application.

12. The method according to claim 1, wherein the at least one organohydrogenpolysiloxane comprises, per molecule, at least three hydrogen atoms bonded to silicon atoms.

13. The method according to claim 1, wherein the at least one hydrosilylation catalyst is a metal belonging to the platinoids.

14. The method according to claim 13, wherein the metal is platinum or rhodium.

15. The method according to claim 1, wherein the at least one hydrosilylation catalyst is selected from the group consisting of a platinum compound, a chloroplatinic acid, a platinum complex, a platinum/vinyl siloxane complex, a Karstedt catalyst comprising a platinum complex with divinyltetramethyldisiloxane as a ligand and mixtures thereof.

16. the method according to claim 1, wherein the at least partially solidified layer(s) become the solidified layer(s) by heating at a temperature in a range of from 40° C. to 190° C.

17. The method according to claim 3, wherein the Brönsted acid is an onium salt.

18. The method according to claim 17, wherein the onium salt is selected from the group consisting of diaryliodonium salt, aryldiazonium salt, alkoxypyridinium salt, triarylsulfonium salt, sulfonium salt and combinations thereof.

19. The method according to claim 3, wherein the Lewis acid is an organometallic salt.

20. The method according to claim 3, wherein the cationic photoinitiator E is selected from the group consisting of diaryliodonium salt, aryldiazonium salt, alkoxypyridinium salt, triaryl sulfonium salt, sulfonium salt and combinations thereof.

21. The method according to claim 20, wherein the cationic photoinitiator E is diaryliodonium salt.

22. The method according to claim 5, wherein the mineral filler is selected from the group consisting of colloidal silica, powder of fumed silica, powder of precipitated silica and mixtures thereof.

23. The method according to claim 6, wherein the amount of the filler F is from 0.1% to 80% by weight.

24. The method according to claim 23, wherein the amount of the filler F is from 0.5% to 50% by weight.

25. The method according to claim 7, wherein the amount of the silicone resin is from 0.1% to 80% by weight.

26. The method according to claim 25, wherein the amount of the silicone resin is from 0.5% to 50% by weight.

27. The method according to claim 8, wherein the weight ratio of the organopolysiloxane A to the epoxy-functional organosilicon compound D is from 0.1 to 40.

28. The method according to claim 27, wherein the weight ratio is from 0.1 to 30.

29. A method of using a three-dimensional (3D) printed article in a 3D printing application, the method comprising employing the 3D printed article according to claim 10 in the 3D printing application.
